(19) United States
(12) Patent Application Publication
(10) Pub. No.: US 2017/0351043 A1
(43) Pub. Date: Dec. 7, 2017

(54) OPTICAL PACKAGE USING V-SHAPED OR CURVED REFLECTOR, AND METHOD FOR MANUFACTURING THE SAME

(71) Applicant: Korea Advanced Institute of Science and Technology, Daejeon (KR)

(72) Inventors: HyoHoon Park, Daejeon (KR); Jong-Hun Kim, Daejeon (KR); Seonghwan Kim, Daejeon (KR)

(73) Assignee: Korea Advanced Institute of Science and Technology, Daejeon (KR)

(21) Appl. No.: 15/239,622

(22) Filed: Aug. 17, 2016

(30) Foreign Application Priority Data
Jun. 7, 2016 (KR) 10-2016-0070224

(51) Int. Cl. G02B 6/42; G02B 5/10; G02B 5/08

(52) U.S. Cl. CPC G02B 6/4214; G02B 5/08; G02B 5/10

(57) ABSTRACT

An optical package according to an embodiment includes a substrate comprising any one of a photodetector or an optical grating coupler and a light source, and a reflector arranged on or over the substrate to reflect light waves radiated from the light source and transmit the reflected light waves to any one of the photodetector or the optical grating coupler.

### CROSS-REFERENCE TO RELATED APPLICATIONS

A claim for priority under 35 U.S.C. §119 is made to Korean Patent Application No. 10-2016-0070224 filed Jun. 7, 2016, in the Korean Intellectual Property Office, the entire contents of which are hereby incorporated by reference.

### BACKGROUND

The inventive concept relates to an optical package including a reflector, and more particularly to a technology of efficiently transmitting, receiving, or coupling light waves by arranging a reflector having a V-shaped or curved structure on or over a light source or a photodetector to decrease divergence of the light waves or to fix an incidence angle of the light waves.

In an optical package according to the related art, an optical waveguide and a photodetector are optically coupled at a low coupling efficiency due to a divergence effect of light waves radiated from a light source.

Accordingly, an optical package technology that uses a transmission path expander that is additionally provided on or over a substrate in which a light source is arranged has been developed. In Korean Patent No. 10-1480025, a transmission path expander includes an optical fiber, which is optically aligned with a light source arranged on or over a substrate to decrease divergence of light waves.

However, in the optical package technology using a transmission path expander, because a process of forming and manufacturing a transmission path expander is very complex, process costs are high and process time is long.

Accordingly, the following embodiments suggest technologies for decreasing divergence of light waves, and lowering the complexity of processes and costs of an optical package and shortening process time by arranging a simple reflector for fixing an incident angle of the light waves.

### SUMMARY

The inventive concept provides an optical package including a simple reflector that decreases divergence of light waves and fixes an incident angle of light waves, and a method for manufacturing the same.

In detail, the inventive concept provides an optical package that includes a reflector having a V-shaped or curved form to decrease divergence of light waves and fixes an incident angle of waves, and a method for manufacturing the same.

In particular, the inventive concept provides an optical package that, when a reflector that has a form having a parabolic surface is provided, efficiently transmits light waves by using a principle that, when light waves radiated from a light source arranged at a focus of a parabolic surface are reflected by the parabolic surface, the light waves always travel in parallel to each other, and a method for manufacturing the same.

In particular, the inventive concept provides an optical package that, when a reflector that has a form having an elliptical surface is provided, efficiently transmits light waves by using a principle that, when light waves radiated from a light source arranged at a focus of an elliptical are reflected by the elliptical surface, the light waves always travel toward another focus of the elliptical surface, and a method for manufacturing the same.

Further, the inventive concept provides an optical package that, when a reflector having a V-shaped form is provided, efficiently transmits light waves by using a principle in which incident angles of light waves reflected twice by the V-shaped surface are determined according to an angle formed by the V-shaped form, and a method for manufacturing the same.

According to an embodiment, an optical package includes a substrate including any one of a photodetector or an optical grating coupler and a light source, and a reflector arranged on or over the substrate to reflect light waves radiated from the light source and transmit the reflected light waves to any one of the photodetector or the optical grating coupler.

The reflector may have any one of a form having two parabolic surfaces, an elliptical form, or a V-shaped form.

When the reflector has the form having the two parabolic surfaces, the light source is arranged at a focus of a first parabolic surface of the reflector, and any one of the photodetector or the optical grating coupler may be arranged at a focus of a second parabolic surface of the reflector, or may be arranged at a location at which the light waves radiated from the light source converge after being reflected twice by the first parabolic surface and the second parabolic surface.

When the reflector has the elliptical form, the light source may be arranged at a focus of the elliptical surface of the reflector, and any one of the photodetector or the optical grating coupler may be arranged at a location at which the light waves radiated from the light source converge after being reflected by the elliptical surface.

When the reflector has the V-shaped form, any one of the photodetector or the optical grating coupler may be arranged on or over the substrate based on a location at which the light source is arranged on or over the substrate and an angle formed by the V-shaped form, or may be arranged at a location at which the light waves radiated from the light source converge after being reflected twice by the V-shaped surface of the reflector.

According to another embodiment, an optical package includes a substrate including any one of a photodetector or a light source, and a parabolic surface reflector arranged on or over the substrate and including any one of an optical fiber or an optical waveguide, and the parabolic surface reflector reflects light waves radiated from the light source to transmit the reflected light waves to any one of the optical fiber or the optical waveguide or reflects the light waves, which travels in any one of the optical fiber or the optical waveguide, to transmit the reflected light waves to the photodetector.

Any one of the light source or the photodetector may be arranged at a focus of the parabolic surface of the parabolic surface reflector.

According to an embodiment, a method for manufacturing an optical package includes providing any one of a photodetector or an optical grating coupler and a light source on or over a substrate, and arranging a reflector on or over the substrate, the reflector being configured to reflect light waves radiated from the light source to transmit the reflected light waves to any one of the photodetector or the optical grating coupler, and the reflector has any one of a form having two parabolic surfaces, an elliptical form, or a V-shaped form.

When the reflector has the form having the two parabolic surfaces, the providing of any one of the photodetector or the optical grating coupler and a light source may include arranging the light source at a focus of a first parabolic surface of the reflector, and arranging any one of the photodetector or the optical grating coupler at a focus of the second parabolic surface of the reflector.

When the reflector has the elliptical form, the providing of any one of the photodetector or the optical grating coupler and a light source on or over a substrate includes arranging the light source at a focus of the elliptical surface of the reflector, and arranging any one of the photodetector or the optical grating coupler at a location at which the light waves radiated from the light source converge after being reflected by the elliptical surface.

When the reflector has the V-shaped form, the providing of any one of the photodetector or the optical grating coupler and a light source on or over a substrate may include arranging the light source at an arbitrary location on the substrate, and arranging any one of the photodetector or the optical grating coupler on the substrate based on a location at which the light source is arranged on the substrate and an angle formed by the V-shaped form.

According to an embodiment, a method for manufacturing an optical package includes providing any one of a photodetector or a light source on or over a substrate, and arranging a parabolic surface reflector including any one of an optical fiber or an optical waveguide on or over the substrate, and the parabolic surface reflector reflects light waves radiated from the light source to transmit the reflected light waves to any one of the optical fiber or the optical waveguide or reflects the light waves, which travels in any one of the optical fiber or the optical waveguide, to transmit the reflected light waves to the photodetector.

The providing of any one of the photodetector or the light source may include arranging any one of the photodetector or the light source at a focus of the parabolic surface of the parabolic surface reflector.

### DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a concept view for explaining the principle of an optical package according to an embodiment;

FIGS. 2A and 2B are views illustrating an optical package according to an embodiment;

FIG. 3 is a view illustrating an optical package that is modified based on the optical package of FIGS. 2A and 2B;

FIG. 4 is a view illustrating an optical package that is modified differently from the optical package of FIG. 3, based on the optical package of FIGS. 2A and 2B;

FIG. 5 is a concept view for explaining the principle of another optical package according to an embodiment;

FIG. 6 is a view illustrating an optical package according to another embodiment;

FIG. 7 is a concept view for explaining the principle of an optical package according to another embodiment;

FIG. 8 is a view illustrating an optical package according to another embodiment;

FIG. 9 is a view illustrating a method for manufacturing an optical package according to an embodiment; and

FIG. 10 is a view illustrating a method for manufacturing an optical package according to another embodiment.

### DETAILED DESCRIPTION

Hereinafter, exemplary embodiments of the inventive concept will be described in detail with reference to the accompanying drawings. However, the inventive concept is neither limited nor restricted by the embodiments. Further, the same reference numerals in the drawings denote the same members.

Furthermore, the terminologies used herein are used to properly express the embodiments of the inventive concept, and may be changed according to the intentions of the user or the manager or the custom in the field to which the inventive concept pertains. Therefore, definition of the terms should be made according to the overall disclosure set forth herein.

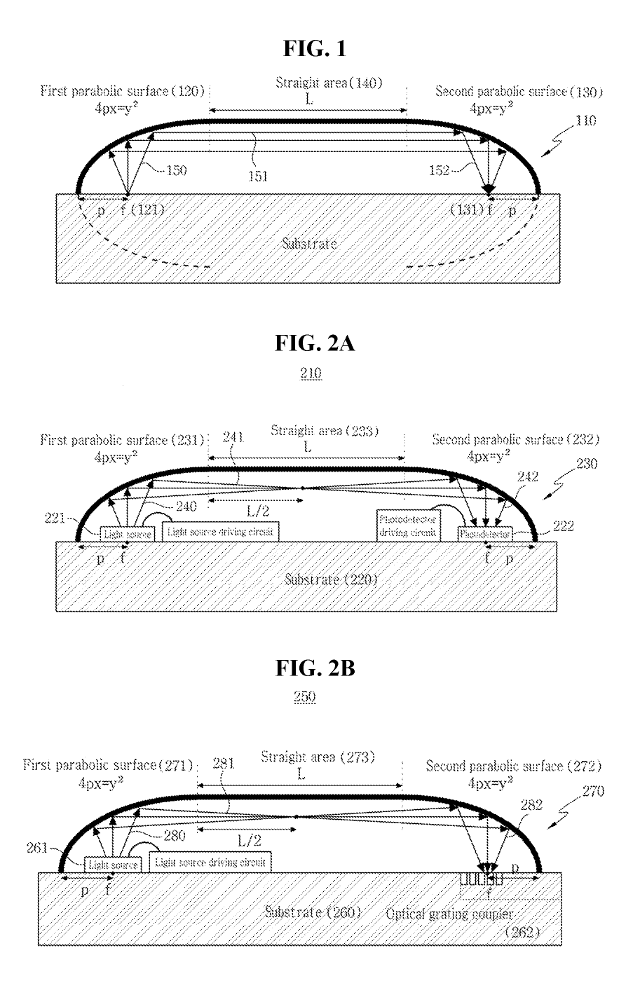

FIG. 1 is a concept view for explaining the principle of an optical package according to an embodiment.

Referring to FIG. 1, an optical package according to an embodiment includes a reflector 110 that has a form having two parabolic surfaces. Here, the reflector 110 includes a first parabolic surface 120, a second parabolic surface 130, and a straight area 140, and the term “a parabolic surface” used herein may mean that a reflective surface has at least one parabolic section. Further, the term “a parabolic surface” may mean that a two-dimensional reflective surface is a paraboloidal surface.

Then, a focus f 121 of the first parabolic surface 120 according to a parabola equation of 4px=y² for a virtual coordinate system x and y is located at a distance that is spaced apart from an apex of the first parabolic surface 120 by p. Similarly, a focus f 131 of the second parabolic surface 130 is also located at a distance that is spaced apart from an apex of the second parabolic surface 130 by p.

Accordingly, when light waves 150 radiated from a light source arranged at the focus 121 of the first parabolic surface 120 of the reflector 110 are reflected by the first parabolic surface 120, first reflective light waves 151 always travel in parallel to each other, and the first reflective light waves 151 that travel in parallel converge at the focus 131 of the second parabolic surface 130 after being reflected by the second parabolic surface 130 (second reflective light waves 152 reflected by the second parabolic surface 130 converge at the focus 131 of the second parabolic surface 130).

Accordingly, the optical package according to an embodiment may efficiently transmit the light waves 150, 151, and 152 based on the above-mentioned principle. A detailed description thereof will be made with reference to FIGS. 2A and 2B.

FIGS. 2A and 2B are views illustrating an optical package according to an embodiment of the inventive concept.

Referring to FIG. 2A, an optical package 210 according to an embodiment includes a substrate 220 including a light source 221 and a photodetector 222, and a reflector 230 arranged on or over the substrate 220. Here, the reflector 230 includes a first parabolic surface 231, a second parabolic surface 232, and a straight area 233.

In the optical package 210, the light source 221 may be arranged at a focus of the first parabolic surface 231 and the photodetector 222 may be arranged at a focus of the second parabolic surface 232, based on the principle described above with reference to FIG. 1. Accordingly, the optical package 210 may be configured such that light waves 240 radiated from the light source 221 converge at the photodetector 222 after being reflected twice by the first parabolic surface 231 and the second parabolic surface 232.

Then, due to restrictions such as the size and height of the light source 221 and the distinct characteristics of the radiated light waves, first reflective light waves 241 obtained after light waves 240 radiated by the light source 221 are reflected by the first parabolic surface 231 may travel while being inclined at a specific inclination, differently from the principle described above with reference to FIG. 1. Accordingly, a plurality of light waves radiated by the light source 221 may travel to the second parabolic surface 232 after crossing at any one point (a point of a location corresponding to a half of the length of the straight area 233) of a space of the straight area 233 of the reflector 230.

However, because the second reflective light wave 242 reflected by the second parabolic curve 232 converge at the focus of the second parabolic surface 232 even though the first reflective light waves 241 travel while being inclined, the optical package 210 may be configured such that the photodetector 222 is arranged at the focus of the second parabolic surface 232.

Further, in a process of arranging the light source 221 and the photodetector 222 of the optical package 210 in the substrate 220, driving circuits that drive the light source 221 and the photodetector 222, respectively, may be connected to the light source 221, and the photodetector 222.

In this way, the optical package 210 may be configured such that the light waves 240 radiated from the light source 221 may be transmitted to the photodetector 222 after being reflected by using the reflector 230 having the first parabolic surface 231 and the second parabolic surface 232. Accordingly, the optical package 210 may reduce divergence or transfer loss of the light waves 240, 241, and 242 in a process of transmitting the light waves 240, 241, and 242 between the light source 221 and the photodetector 222 and may align the light waves 240, 241, and 242.

Further, the optical package 210 may have a structure including an optical grating coupler instead of the photodetector 222. A detailed description thereof will be made with reference to FIG. 2B.

Referring to FIG. 2B, an optical package 250 according to an embodiment includes a substrate 260 including a light source 261 and an optical grating coupler 262, and a reflector 270 arranged on or over the substrate 260. Here, the reflector 270 includes a first parabolic surface 271, a second parabolic surface 272, and a straight area 273. In the following description, the optical grating coupler 262 has a structure including an optical waveguide.

In the optical package 250, the light source 261 may be arranged at a focus of the first parabolic surface 271 and the optical grating coupler 262 may be arranged at a focus of the second parabolic surface 272, based on the principle described above with reference to FIG. 1. Accordingly, the optical package 250 may be configured such that light waves 280 radiated from the light source 261 converge at the optical grating coupler 262 after being reflected twice by the first parabolic surface 271 and the second parabolic surface 272.

Then, a process of arranging the optical grating coupler 262 on or over the substrate 260 may include a photonic integrated circuit process based on a general semiconductor or polymer process.

Here, due to restrictions such as the size and height of the light source 261 and the distinct characteristics of the radiated light waves 280, first reflective light waves 28 obtained after light waves 280 radiated by the light source 261 are reflected by the first parabolic surface 271 may travel while being inclined at a specific inclination, differently from the principle described above with reference to FIG. 1. Accordingly, a plurality of light waves radiated by the light source 261 may travel to the second parabolic surface 272 after crossing at any one point (a point of a location corresponding to a half of the length of the straight area 273) of a space of the straight area 273 of the reflector 270.

However, because the second reflective light wave 282 reflected by the second parabolic curve 272 converge at the focus of the second parabolic surface 272 even though the first reflective light waves 281 travel while being inclined, the optical package 250 may be configured such that the optical grating coupler 262 is arranged at the focus of the second parabolic surface 272.

Further, in a process of arranging the light source 261 of the optical package 250 in the substrate 260, a driving circuit that drives the light source 261 may be connected to the light source 261.

In this way, the optical package 250 may be configured such that the light waves 280 radiated from the light source 261 may be transmitted to the photodetector 262 after being reflected by using the reflector 270 having the first parabolic surface 271 and the second parabolic surface 272 and optical coupling may be performed by the optical grating coupler 262. Accordingly, the optical package 250 may reduce divergence or transfer loss of the light waves 280, 281, and 282 in a process of transmitting the light waves 280, 281, and 282 between the light source 261 and the optical grating coupler 262, may align the light waves 280, 281, and 282, and may increase optical coupling efficiency in the optical grating coupler 262.

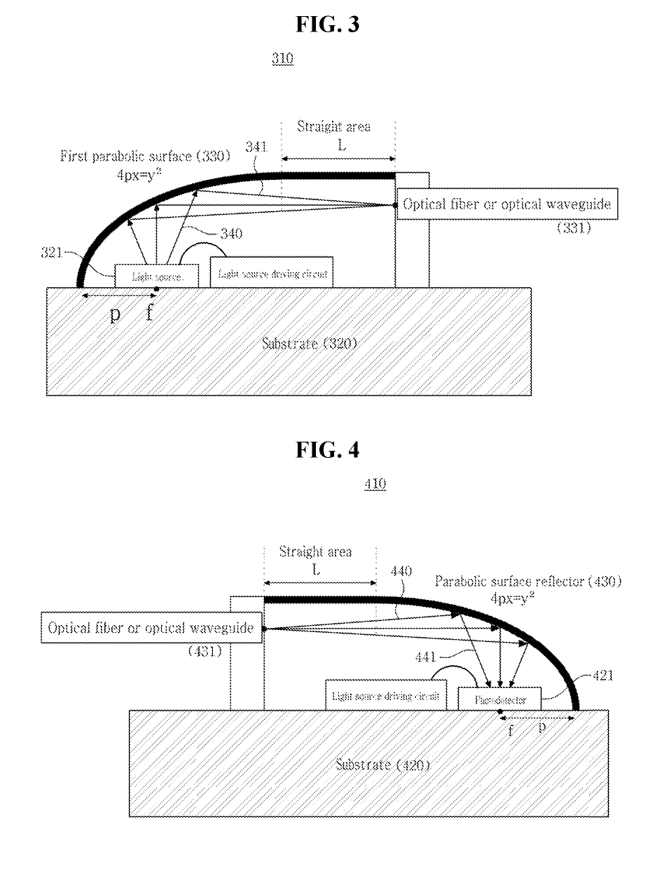

FIG. 3 is a view illustrating an optical package that is modified based on the optical package of FIGS. 2A and 2B.

Referring to FIG. 3, an optical package 310 according to an embodiment includes a substrate 320 including a light source 321, and a parabolic surface reflector 330 arranged on or over the substrate 320. Here, unlike the reflector described above with reference to FIGS. 2A and 2B, the parabolic surface reflector 330 may include any one 331 of an optical fiber or an optical waveguide in a form having only one parabolic surface.

The optical package 310 may be configured such that the light source 321 may be arranged at a focus of a parabolic surface of the parabolic surface reflector 330 based on the principle described above with reference to FIG. 1. Accordingly, the optical package 310 may be configured such that light waves 340 radiated from the light source 321 may converge at any one 331 of an optical fiber or an optical waveguide after being reflected once by the parabolic surface.

Then, due to restrictions such as the size and height of the light source 321 and the distinct characteristics of the radiated light waves, first reflective light waves 341 obtained after light waves 340 radiated by the light source 321 are reflected by the parabolic surface may travel while being inclined at a specific inclination, in the same principle as described above with reference to FIGS. 2A and 2B.

Accordingly, in the optical package 310, a location at which any one 331 of the optical fiber or the optical waveguide is arranged in the parabolic surface reflector 330 may be determined such that the reflective light waves 341 that travel while being inclined may converge at any one of the optical fiber or the optical waveguide. For example, in the optical package 310, any one 331 of the optical fiber or the optical waveguide may be arranged at a specific location of the parabolic surface reflector 330 corresponding to any one point at which a plurality of light waves cross (any one point at which the reflective light waves 341 radiated by the light source 321 converge after being reflected by the parabolic surface), based on the characteristics in which the plurality of light waves radiated by the light source cross at any one point in a space in a straight area of the reflector (one point of a location corresponding to a half of the length of the straight area) as described above with reference to FIGS. 2A and 2B.

Further, in a process of arranging the light source 321 of the optical package 310 in the substrate 320, a driving circuit that drives the light source 321 may be connected to the light source 321.

In this way, by using the parabolic surface reflector 330, the optical package 310 may reflect the light waves 340 radiated from the light source 321 and transmit the reflected light waves 340 to any one 331 of the optical fiber or the optical waveguide. Accordingly, the optical package 310 may reduce divergence or transfer loss of the light waves 340 and 341 in a process of transmitting the light waves 340 and 341 between the light source 321 and any one of the optical fiber or the optical waveguide and may align the light waves 340 and 341.

FIG. 4 is a view illustrating an optical package that is modified differently from the optical package of FIG. 3, based on the optical package of FIGS. 2A and 2B.

Referring to FIG. 4, an optical package 410 according to an embodiment includes a substrate 420 including a photodetector 421, and a parabolic surface reflector 430 arranged on or over the substrate 420. Here, unlike the reflector described above with reference to FIGS. 2A and 2B, the parabolic surface reflector 430 may include any one 431 of an optical fiber or an optical waveguide in a form having only one parabolic surface.

The optical package 410 may be configured such that the photodetector 421 may be arranged at a focus of a parabolic surface of the parabolic surface reflector 430 based on the principle described above with reference to FIG. 1. Accordingly, the optical package 410 may be configured such that light waves 440 that travels in any one 431 of an optical fiber or an optical waveguide may converge at the photodetector 421 after being reflected once by the parabolic surface.

Then, due to restrictions such as the size and height of any one 431 of the optical fiber or the optical waveguide and the distinct characteristics of the light waves 440, the light waves 440 radiated into a space after traveling in any one 431 of the optical fiber or the optical waveguide may travel while being inclined at a specific inclination in the same principle as described with reference to FIGS. 2A and 2B.

However, because the reflective light waves 441 reflected by the parabolic surface converge at the focus of the parabolic surface even when the light waves 440 travel while being inclined, the photodetector 421 of the optical package 410 may be arranged at the focus of the parabolic surface.

Further, the optical package 410 may be configured such that a location at which any one 431 of the optical fiber or the optical waveguide may be determined such that the light waves 340 that travel while being inclined may converge at the photodetector 421 after being reflected by the parabolic surface.

Further, in a process of arranging the photodetector 420 of the optical package 410 in the substrate 420, a driving circuit that drives the photodetector 421 may be connected to the photodetector 221.

Accordingly, the optical package 410 may be configured such that light waves 440 that travels in any one 431 of an optical fiber or an optical waveguide may be transmitted to the photodetector 421 after being reflected, by using the parabolic surface reflector 430. Accordingly, the optical package 410 may reduce divergence or transfer loss of the light waves 440 and 441 in a process of transmitting the light waves 440 and 441 between any one 431 of the optical fiber or the optical waveguide and the photodetector 421 and may align the light waves 440 and 441.

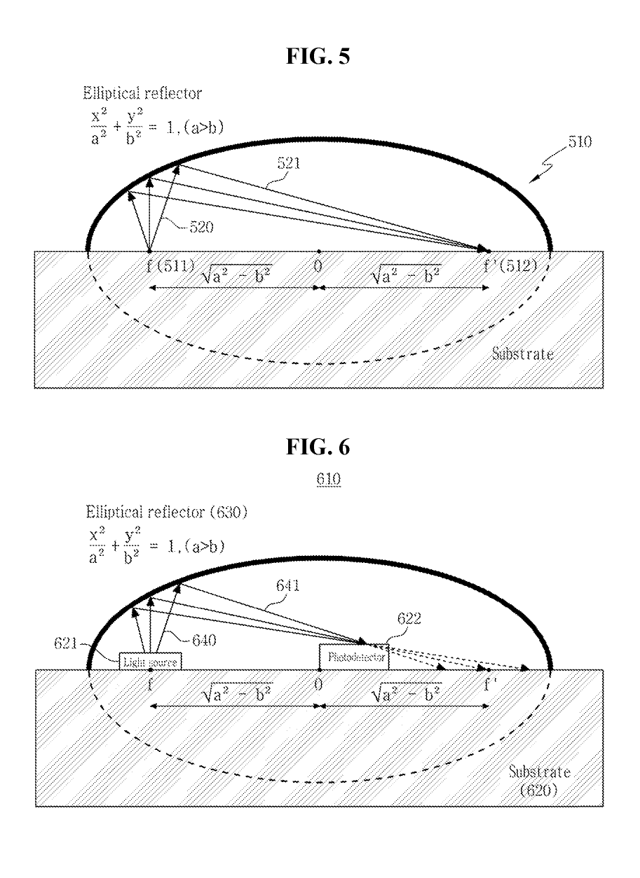

FIG. 5 is a concept view for explaining the principle of another optical package according to an embodiment.

Referring to FIG. 5, an optical package according to another embodiment includes a reflector 510 having an elliptical form. Here, the reflector 510 includes an elliptical surface.

Further, the term “an elliptic surface” used herein may mean that a reflective surface as at least one elliptic section. Further, the term “an elliptic surface” may mean that a two-dimensional reflective surface is an ellipsoidal surface.

Then, a first focus f 511 of the elliptical surface according to an ellipse equation of

$$\frac{{x}^{2}}{{a}^{2}} + \frac{{y}^{2}}{{b}^{2}} = 1 , ( a > b )$$

for a virtual coordinate system x and y is located at a distance that is spaced apart from the center of an ellipse by \sqrt{a²−b²}. Here, a represents a long axis and b represents a short axis in the ellipse equation. Similarly, a second focus f 512 of the elliptical surface is located at a distance that is spaced apart from the center of the ellipse by \sqrt{a²−b²}.

Accordingly, when the light waves 520 radiated from the light source arranged at the first focus 511 of the elliptical surface of the reflector 510 are reflected by the elliptical surface, the reflective light waves 521 converge at the second focus 512 of the elliptical surface.

Accordingly, the optical package according to another embodiment may efficiently transmit the light waves 520 and 521 based on the above-mentioned principle. A detailed description thereof will be made with reference to FIG. 6.

FIG. 6 is a view illustrating an optical package according to another embodiment.

Referring to FIG. 6, an optical package 610 according to another embodiment includes a substrate 620 including a light source 621 and a photodetector 622, and a reflector 630 arranged on or over the substrate 620. Here, the reflector 630 has an elliptical form having an elliptical surface.

The optical package 610 may be configured such that the light source 621 may be arranged at a focus of an elliptical surface and the photodetector 622 may be arranged at another focus of the elliptical surface based on the principle described above with reference to FIG. 5. Accordingly, the optical package 610 may be configured such that light waves 640 radiated from the light source 621 may converge at the photodetector 622 after being reflected once by the elliptical surface.

Then, due to restrictions such as the size and height of the light source 621 and the distinct characteristics of the radiated light waves, first reflective light waves 641 obtained after light waves 640 radiated by the light source 621 are reflected by the elliptical surface may travel towards a side that is located rather in front of another focus of the elliptical surface, differently from the principle as described above with reference to FIG. 5.

Accordingly, the optical package 610 may be configured such that the photodetector 622 may be arranged at a location at which the light waves 640 radiated from the light source 621 converge after being reflected by the elliptical surface (a location at which the reflective light waves 641 converge).

Further, in a process of arranging the light source 621 of the optical package 610 in the substrate 620, a driving circuit that drives the light source 621 may be connected to the light source 621.

In this way, the optical package 610 may be configured such that the light waves 640 radiated from the light source 621 may be transmitted to the photodetector 622 after being reflected by using the reflector 630 having the parabolic surface. Accordingly, the optical package 610 may reduce divergence or transfer loss of the light waves 640 and 641 in a process of transmitting the light waves 640 and 641 between the light source 621 and the photodetector 622 and may align the light waves 640 and 641.

Further, the optical package 610 may have a structure including an optical grating coupler instead of the photodetector 622. A detailed description thereof may be inferred from the description of FIGS. 2A and 2B and the description of FIG. 6, and thus will be omitted.

FIG. 7 is a concept view for explaining the principle of an optical package according to another embodiment.

Referring to FIG. 7, an optical package according to another embodiment includes a reflector 710 having a V-shaped form. Here, the reflector 710 includes a V-shaped surface.

Then, an incident angle at which the reflective light waves 721 that are obtained by reflecting the light waves 720 radiated form a light source arranged at an arbitrary location of the substrate is input to the substrate is determined by an angle θ formed by the V-shaped form of the reflector 710, regardless of an angle at which the light waves 720 are radiated from the light source. For example, an incident angle at which the reflective light waves 721 are input to the substrate is determined to be 2θ−90.

Accordingly, the reflective light waves 721 converge at an arbitrary location on the substrate, based on a location of the light source that radiates the light waves 720 and an angle formed by the V-shaped form.

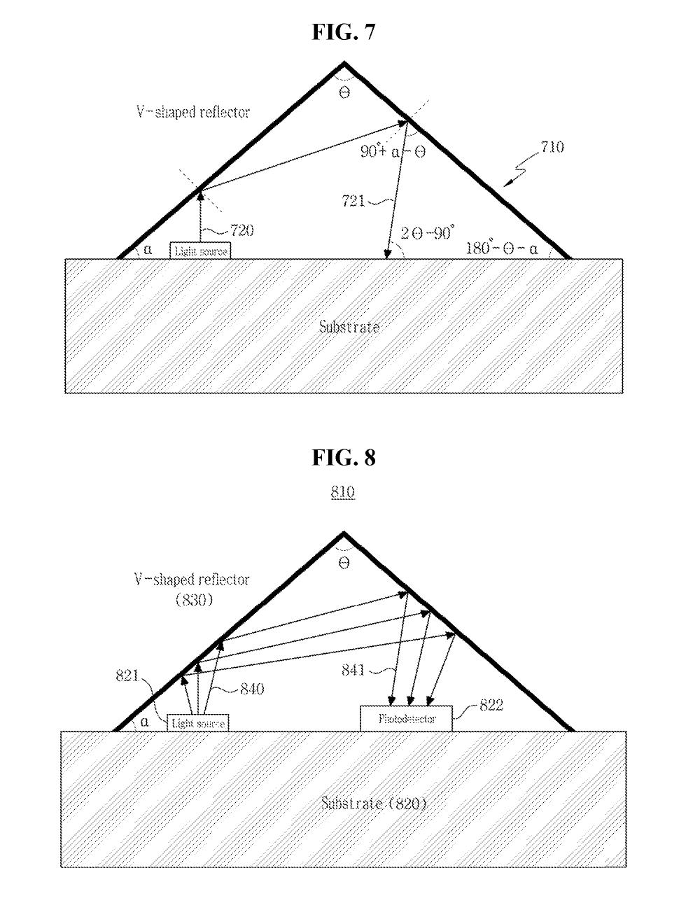

Accordingly, the optical package according to another embodiment may efficiently transmit the light waves 720 and 721 based on the above-mentioned principle. A detailed description thereof will be made with reference to FIG. 8.

FIG. 8 is a view illustrating an optical package according to another embodiment.

Referring to FIG. 8, an optical package 810 according to another embodiment includes a substrate 820 including a light source 821 and a photodetector 822, and a reflector 830 arranged on or over the substrate 820. Here, the reflector 830 has a V-shaped form having a V-shaped surface.

The optical package 810 may be configured such that the light source 821 may be arranged at an arbitrary location based on the principle described above with reference to FIG. 7 and the photodetector 822 may be arranged on the substrate 820 based on a location at which the light source 821 is arranged and an angle formed by the V-shaped form. Accordingly, the optical package 810 may be configured such that the reflective light waves 841 reflected twice by the V-shaped surface may converge at the photodetector 822 through a fixed incident angle.

That is, the photodetector 822 may be arranged at a location at which the light waves 840 radiated from the light source 821 converge after being reflected twice by the V-shaped surface (a location at which the reflective light waves 841 reflected twice by the V-shaped surface converge).

Further, in a process of arranging the light source 821 of the optical package 810 in the substrate 820, a driving circuit that drives the light source 821 may be connected to the light source 821.

In this way, the optical package 810 may be configured such that the light waves 840 radiated from the light source 821 may be transmitted to the photodetector 822 after being reflected by using the reflector 830 having the V-shaped surface. Accordingly, the optical package 810 may reduce divergence or transfer loss of the light waves 840 and 841 in a process of transmitting the light waves 840 and 841 between the light source 821 and the photodetector 822 and may align the light waves 840 and 841. Further, in the optical package 810, an incident angle at which the light waves are input to the photodetector 822 is fixed regardless of radiation angles of the light waves 840.

Further, the optical package 810 may have a structure including an optical grating coupler instead of the photodetector 822. A detailed description thereof may be inferred from the description of FIGS. 2A and 2B and the description of FIG. 8, and thus will be omitted.

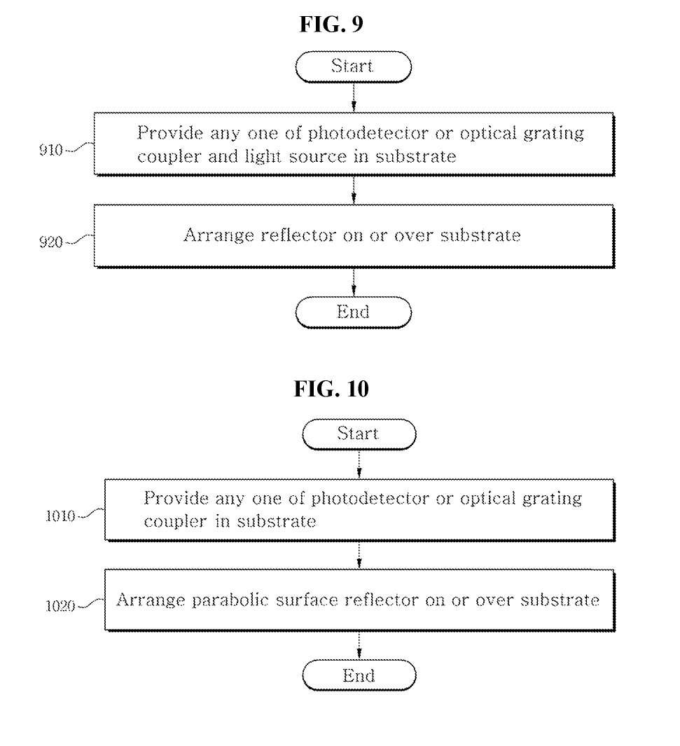

FIG. 9 is a view illustrating a method for manufacturing an optical package according to an embodiment.

Referring to FIG. 9, a method for manufacturing an optical package according to an embodiment is performed by a system for manufacturing an optical package. In the following description, a method for manufacturing an optical package according to an embodiment relates to a method for manufacturing the optical packages described above with reference to FIGS. 2A and 2B, 6, and 8.

Although not illustrated, the system for manufacturing an optical package may include a reflector that has any one of a form having two parabolic surfaces, an elliptical form or a V-shaped form.

The system for manufacturing an optical package includes any one of a photodetector or an optical grating coupler and a light source (910).

For example, when the reflector has a form having two parabolic surfaces, in operation 910, the system for manufacturing an optical package may be configured such that a light source may be arranged at a focus of a first parabolic surface of the reflector and any one of a photodetector or an optical grating coupler may be arranged at a focus of a second parabolic surface of the reflector. Then, the description that any one of a photodetector or an optical grating coupler is arranged at a focus of the second parabolic surface of the reflector may mean that any one of a photodetector or an optical grating coupler may be arranged at a location at which light waves radiated from a light source converge after being reflected twice by the first parabolic surface and the second parabolic surface.

As another example, when the reflector has an elliptical form, in operation 910, the system for manufacturing an optical package may be configured such that a light source is arranged at a focus of an elliptical surface of the reflector and any one of a photodetector or an optical grating coupler may be arranged at a location at which light waves radiated from a light source converge after being reflected by the elliptical surface. Here, the description that any one of a photodetector or an optical grating coupler is arranged at a location at which light waves radiated from a light source converge after being reflected by an elliptical surface may mean that any one of a photodetector or an optical grating coupler may be arranged at another focus of the elliptical surface.

As another example, when the reflector has a V-shaped form, in operation 910, the system for manufacturing an optical package may be configured such that a light source is arranged at an arbitrary location on a substrate and any one of a photodetector or an optical grating coupler may be arranged on a substrate based on a location at which a light source is arranged on the substrate and an angle formed by the V-shaped form. Then, the description that any one of a photodetector or an optical grating coupler is arranged based on a location at which a light source is arranged on a substrate and an angle formed by a V-shaped form may mean that any one of a photodetector or an optical grating coupler may be arranged at a location at which light waves radiated from a light source converge after being reflected twice by the V-shaped surface.

Thereafter, in the system for manufacturing an optical package, a reflector that reflects light waves radiated from the light source and transmits the reflected light waves to any one of the photodetector or the optical grating coupler is arranged on or over the substrate (920).

FIG. 10 is a view illustrating a method for manufacturing an optical package according to another embodiment.

Referring to FIG. 10, the method for manufacturing an optical package according to the other embodiment is performed by a system for manufacturing an optical package, and relates to a method for manufacturing the optical packages described above with reference to FIGS. 3 and 4.

Although not illustrated, the system for manufacturing an optical package may have a parabolic surface reflector that has a form having one parabolic surface.

The system for manufacturing an optical package includes any one of a photodetector or a light source (1010).

In detail, in operation 1010, in the system for manufacturing an optical package, any one of a photodetector or a light source may be arranged at a focus of a parabolic surface of the parabolic surface reflector.

Thereafter, in the system for manufacturing an optical package, a parabolic surface reflector including any one of an optical fiber or an optical waveguide is arranged on or over the system (1020).

Here, the parabolic surface reflector reflects light waves radiated from the light source to transmit the reflected light waves to any one of the optical fiber or the optical waveguide or reflects the light waves that travels in any one of the optical fiber or the optical waveguide to transmit the reflected light waves to the photodetector

Further, any one of the optical fiber or the optical waveguide of the parabolic surface reflector may be arranged at a location at which light waves radiated from the light source converge after being reflected by the parabolic surface or at a location at which light waves that travel in any one of the optical fiber or the optical waveguide converge at the photodetector after being reflected by the parabolic surface.

The inventive concept can provide an optical package including a simple reflector that decreases divergence of light waves and fixes an incident angle of light waves, and a method for manufacturing the same.

Accordingly, the inventive concept can provide an optical package that may be align light waves by providing a simple reflector that decreases divergence of the light waves and fixes an incident angle, may increase optical coupling efficiency, and may minimize light wave transfer loss, and a method for manufacturing the same.

Accordingly, the inventive concept can provide a technology for an optical package that lowers process complexity and costs and shorten process time.

In detail, the inventive concept can provide an optical package that includes a reflector having a V-shaped or curved form to decrease divergence of light waves and fix an incident angle of waves, and a method for manufacturing the same.

In particular, the inventive concept can provide an optical package that, when a reflector that has a form having a parabolic surface, efficiently transmits light waves by using a principle that, when light waves radiated from a light source arranged at a focus of a parabolic surface are reflected by the parabolic surface, the light waves always travel in parallel to each other, and a method for manufacturing the same.

In particular, the inventive concept can provide an optical package that, when a reflector that has a form having an elliptical surface, efficiently transmits light waves by using a principle that, when light waves radiated from a light source arranged at a focus of an elliptical are reflected by the elliptical surface, the light waves always travel toward another focus of the elliptical surface, and a method for manufacturing the same.

Further, the inventive concept can provide an optical package that, when a reflector having a V-shaped form is provided, efficiently transmits light waves by using a principle in which incident angles of light waves reflected twice by the V-shaped surface are determined according to an angle formed by the V-shaped form, and a method for manufacturing the same.

Although the embodiments of the inventive concept have been described with reference to the limited embodiments and the drawings, the inventive concept may be variously corrected and modified from the above description by those skilled in the art to which the inventive concept pertains. For example, the above-described technologies can achieve a suitable result even though they are performed in different sequences from those of the above-mentioned method and/or coupled or combined in different forms from the method in which the constituent elements such as the system, the architecture, the device, or the circuit are described, or replaced or substituted by other constituent elements or equivalents.

Therefore, the other implementations, other embodiments, and the equivalents of the claims pertain to the scope of the claims.

The embodiments of the invention in which an exclusive property or privilege is claimed are defined as follows:

1. An optical package comprising:
a substrate comprising any one of a photodetector or an optical grating coupler and a light source; and
a reflector arranged on or over the substrate to reflect light waves radiated from the light source and transmit the reflected light waves to any one of the photodetector or the optical grating coupler.

2. The optical package of claim 1, wherein the reflector has any one of a form having two parabolic surfaces, an elliptical form, or a V-shaped form.

3. The optical package of claim 2, wherein when the reflector has the form having the two parabolic surfaces, the light source is arranged at a focus of a first parabolic surface of the reflector, and any one of the photodetector or the optical grating coupler is arranged at a focus of a second parabolic surface of the reflector, or is arranged at a location at which the light waves radiated from the light source converge after being reflected twice by the first parabolic surface and the second parabolic surface.

4. The optical package of claim 2, wherein when the reflector has the elliptical form, the light source is arranged at a focus of the elliptical surface of the reflector, and any one of the photodetector or the optical grating coupler is arranged at a location at which the light waves radiated from the light source converge after being reflected by the elliptical surface.

5. The optical package of claim 2, wherein when the reflector has the V-shaped form, any one of the photodetector or the optical grating coupler is arranged on or over the substrate based on a location at which the light source is arranged on or over the substrate and an angle formed by the V-shaped form, or is arranged at a location at which the light waves radiated from the light source converge after being reflected twice by the V-shaped surface of the reflector.

6. An optical package comprising:
a substrate comprising any one of a photodetector or a light source; and
a parabolic surface reflector arranged on or over the substrate and comprising any one of an optical fiber or an optical waveguide,
wherein the parabolic surface reflector reflects light waves radiated from the light source to transmit the reflected light waves to any one of the optical fiber or the optical waveguide or reflects the light waves, which travels in any one of the optical fiber or the optical waveguide, to transmit the reflected light waves to the photodetector.

7. The optical package of claim 6, wherein any one of the light source or the photodetector is arranged at a focus of the parabolic surface of the parabolic surface reflector.

8. A method for manufacturing an optical package, the method comprising:
providing any one of a photodetector or an optical grating coupler and a light source on or over a substrate; and
arranging a reflector on or over the substrate, the reflector being configured to reflect light waves radiated from the light source to transmit the reflected light waves to any one of the photodetector or the optical grating coupler,
wherein the reflector has any one of a form having two parabolic surfaces, an elliptical form, or a V-shaped form.

9. The method of claim 8, wherein when the reflector has the form having the two parabolic surfaces, the providing of any one of the photodetector or the optical grating coupler and a light source comprises:
arranging the light source at a focus of a first parabolic surface of the reflector; and
arranging any one of the photodetector or the optical grating coupler at a focus of the second parabolic surface of the reflector.

10. The method of claim 8, wherein when the reflector has the elliptical form, the providing of any one of the photodetector or the optical grating coupler and a light source on or over a substrate comprises:
arranging the light source at a focus of the elliptical surface of the reflector; and
arranging any one of the photodetector or the optical grating coupler at a location at which the light waves radiated from the light source converge after being reflected by the elliptical surface.

11. The method of claim 8, wherein when the reflector has the V-shaped form, the providing of any one of the photodetector or the optical grating coupler and a light source on or over a substrate comprises:
arranging the light source at an arbitrary location on the substrate; and
arranging any one of the photodetector or the optical grating coupler on the substrate based on a location at which the light source is arranged on the substrate and an angle formed by the V-shaped form.

12. A method for manufacturing an optical package, the method comprising:
providing any one of a photodetector or a light source on or over a substrate; and
arranging a parabolic surface reflector comprising any one of an optical fiber or an optical waveguide on or over the substrate,
wherein the parabolic surface reflector reflects light waves radiated from the light source to transmit the reflected light waves to any one of the optical fiber or the optical waveguide or reflects the light waves, which travels in any one of the optical fiber or the optical waveguide, to transmit the reflected light waves to the photodetector.

13. The method of claim 12, wherein the providing of any one of the photodetector or the light source comprises:
arranging any one of the photodetector or the light source at a focus of the parabolic surface of the parabolic surface reflector.
